(19) United States
(12) Patent Application Publication
(10) Pub. No.: US 2017/0312935 A1
(43) Pub. Date: Nov. 2, 2017

(54) MULTI-BLADE TYPE WOODWORKING BIT

(71) Applicant: Compass Corporation, Tainan City (TW)

(72) Inventor: Tzu-Chien Wang, Tainan City (TW)

(21) Appl. No.: 15/143,616

(22) Filed: May 1, 2016

(51) Int. Cl. B27G 15/00; B23B 51/00

(52) U.S. Cl. CPC B27G 15/00; B23B 51/009; B23B 2251/18; B23B 2251/408; B23B 2251/204

(57) ABSTRACT

A multi-blade type woodworking bit includes a driving section for coupling with an external tool and a working section in front of the driving section. The working section includes a first cutting section and a second cutting section behind the first cutting section. The first cutting section is conic and has a front pointed end. The first cutting section further includes at least two angularly spaced first dust discharge grooves. The second cutting section includes a shank portion axially connected to a rear end of the first cutting section. At least two angularly spaced blades extend radially from the shank portion. Each blade includes a front cutting end. A rear end of each first dust discharge groove is located between a pair of blades. A second dust discharge groove is formed between each pair of blades and has a width lager than a width of each first dust discharge groove.

### BACKGROUND OF THE INVENTION

The present invention relates to a multi-blade type woodworking bit and, more particularly, to a multi-blade type woodworking bit for rapidly discharging wood dust to assure an easy, smooth hole drilling operation and safety.

Conventional woodworking bits generally include a driving section on a rear end thereof and a working section on a front end thereof. The driving section is coupled to an electric or pneumatic tool. The working section is flat and includes a pointed guiding end at a front end thereof. A blade portion is provided behind the guiding end and is wider than the guiding end. A front end of the blade portion includes two sides each having a pointed end. During a cutting process, the guiding end of the working section rotationally cuts a workpiece to assure a stable path for the woodworking hole drilling operation. Then, the blade portion of the working section rotationally cuts a hole with a desired diameter in the workpiece.

However, the flat design of the guiding end and the blade portion of the above woodworking bit cannot provide smooth and easy discharge of the wood dust, such that the wood dust accumulates around the woodworking bit and in the hole of the workpiece during the cutting procedure, adversely affecting the smoothness of the hole drilling operation. Furthermore, the high temperature resulting from high speed cutting of the workpiece causes friction and burning of the wood dust accumulated in the hole of the workpiece, deteriorating and damaging the woodworking bit and the workpiece and leading to unsafe operation.

### BRIEF SUMMARY OF THE INVENTION

An objective of the present invention is to provide a multi-blade type woodworking bit for rapidly discharging wood dust to assure an easy, smooth hole drilling operation and safety.

A multi-blade type woodworking bit according to the present invention includes a driving section and a working section. The driving section is adapted to couple with an external tool. The working section is located in front of the driving section. The working section includes a first cutting section and a second cutting section behind the first cutting section. The first cutting section is conic and has a front pointed end. The first cutting section further includes an outer periphery having at least two first dust discharge grooves spaced from each other in an angular direction. The second cutting section includes a shank portion axially connected to a rear end of the first cutting section. At least two blades extend radially from an outer periphery of the shank portion and are spaced from each other in the angular direction. Each of the at least two blades includes a front cutting end. A rear end of each of the at least two first dust discharge grooves is located between a pair of blades adjacent to each other. A second dust discharge groove is formed between each pair of blades adjacent to each other and has a width lager than a width of each of the at least two first dust discharge grooves. The second cutting section generates rearward guiding air currents when the multi-blade type woodworking bit rotates.

Each of the at least two first dust discharge grooves can have a spiral curvature corresponding to a spiral curvature of one of the at least two blades.

Each of the at least two second dust discharge grooves of the second cutting section can include a ridge extending axially along a central portion thereof. Each ridge includes a front end connected to the rear end of one of the at least two first dust discharge grooves. Two guiding grooves for flow division are formed between two sides of each ridge and a pair of blades adjacent to each other.

In an example, the first cutting section includes four first dust discharge grooves spaced from each other by 90°, and the second cutting section includes four blades spaced from each other by 90°. The rear end of each of the four first dust discharge grooves is located at a middle between a pair of blades adjacent to each other.

Since the first and second cutting sections include first and second dust discharge grooves for continuous discharge of wood dust, the wood dust generated during the hole drilling operation will not accumulate in the hole to provide better smoothness in the hole drilling operation while avoiding friction between the wood dust that may lead to high temperature and potential smoking or burning, providing enhanced safety effect.

The present invention will become clearer in light of the following detailed description of illustrative embodiments of this invention described in connection with the drawings.

### DESCRIPTION OF THE DRAWINGS

FIG. 1 is a perspective view of a multi-blade type woodworking bit according to the present invention.

FIG. 2 is a partial side view of the multi-blade type woodworking bit of FIG. 1.

FIG. 3 is a cross sectional view taken along section line A-A of FIG. 2.

FIG. 4 is a cross sectional view taken along section line B-B of FIG. 2.

FIG. 5 is a diagrammatic view illustrating an initial stage of a hole drilling operation of the multi-blade type woodworking bit of FIG. 1.

FIG. 6 is a diagrammatic view illustrating a subsequent stage of the hole drilling operation of the multi-blade type woodworking bit of FIG. 5.

### DETAILED DESCRIPTION OF THE INVENTION

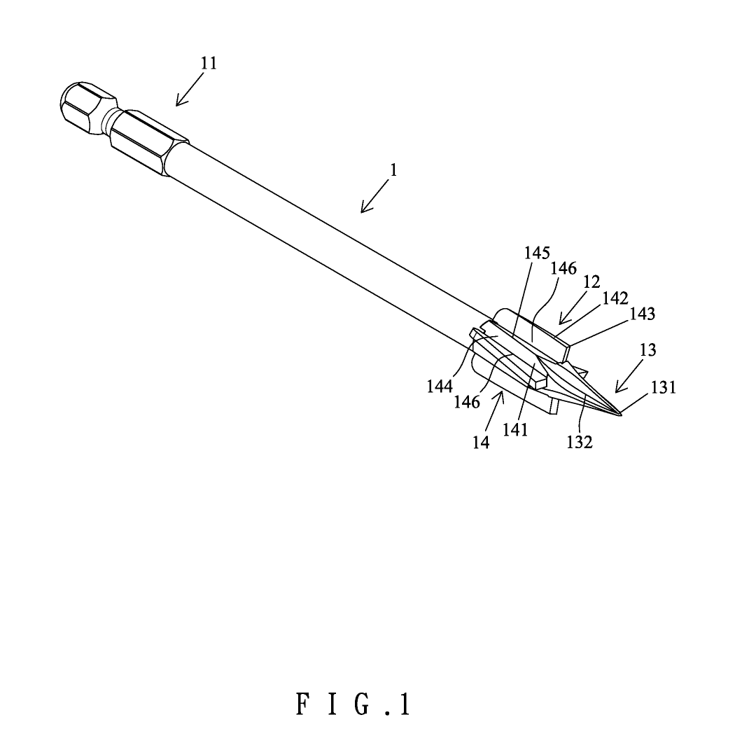

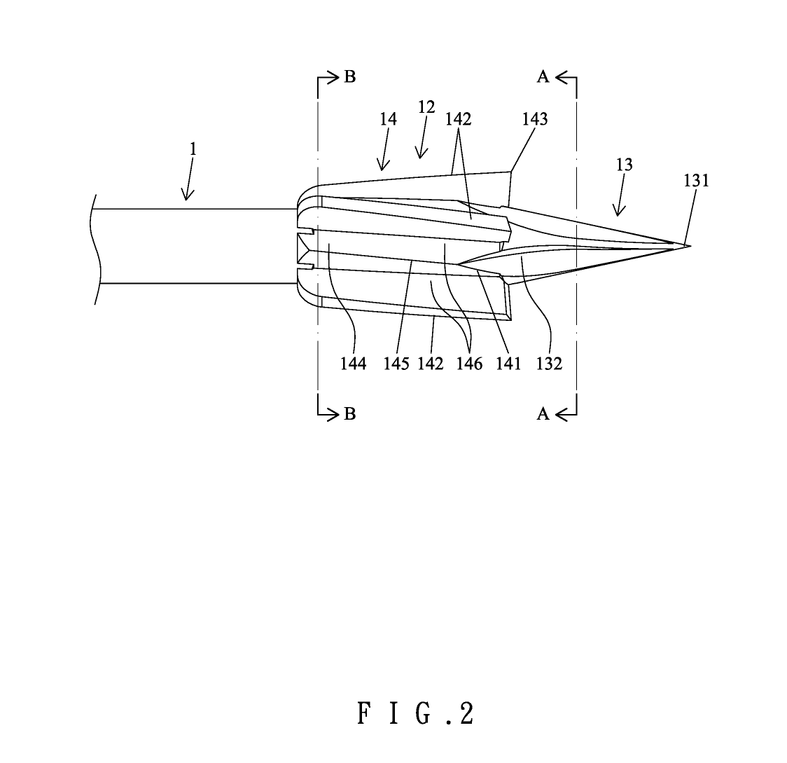

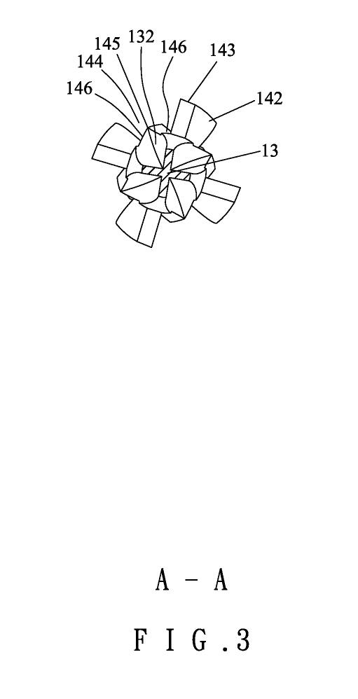

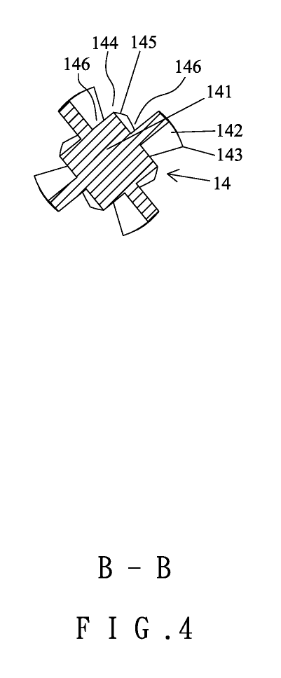

With reference to FIGS. 1-4, a multi-blade type woodworking bit 1 according to the preset invention is elongated and includes a driving section 11 and a working section 12. The driving section 11 is adapted to couple with an external tool (not shown), such as a pneumatic tool, an electric tool, or a hand tool. The working section 12 is located in front of the driving section 11 and includes a first cutting section 13 and a second cutting section 14 behind the first cutting section 13. The first cutting section 13 is conic and has a front pointed end 131. The first cutting section 13 further includes an outer periphery having at least two first dust discharge grooves 132 spaced from each other in an angular direction. In this embodiment, the first cutting section 13 includes four first dust discharge grooves 132 spaced from each other by 90°.

In this embodiment, the second cutting section 14 includes a shank portion 141 axially connected to a rear end of the first cutting section 13. Four blades 142 extend radially from an outer periphery of the shank portion 141 and are spaced from each other by 90°. Each blade 142 includes a front cutting end 143. A rear end of each first dust discharge groove 132 is located at a middle between a pair of blades 142 adjacent to each other. A second dust discharge groove 144 is formed between each pair of blades 142 adjacent to each other and has a width lager than a width of each first dust discharge groove 132.

Each blade 142 has a spiral curvature. Each first dust discharge groove 132 has a spiral curvature corresponding to the spiral curvature of one of the blades 142. Each second dust discharge groove 144 of the second cutting section 14 includes a ridge 145 extending axially along a central portion thereof. Each ridge 145 includes a front end connected to the rear end of one of the first dust discharge grooves 132. Two guiding grooves 146 for flow division are formed between two sides of each ridge 145 and a pair of blades 142 adjacent to each other.

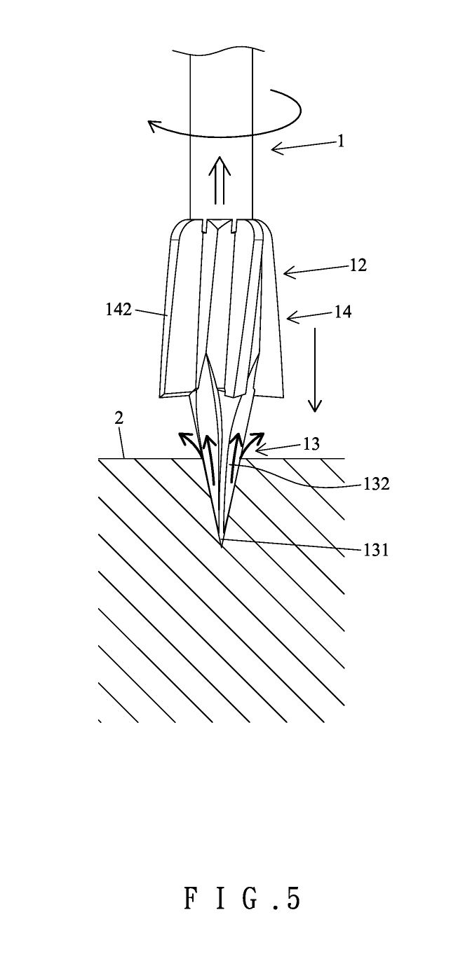

With reference to FIG. 5, when it is desired to rotate the woodworking bit 1 to proceed with a hole drilling operation, the front pointed end 131 of the first cutting section 13 of the working section 12 rotates into a surface of a workpiece 2 and provides a route positioning effect. The wood dust (not shown) generated while the first cutting section 13 continuously drills into the workpiece 2 can be discharged rearward via the first dust grooves 132. The rotating blades 142 generate rearward guiding air currents (see the double arrow).

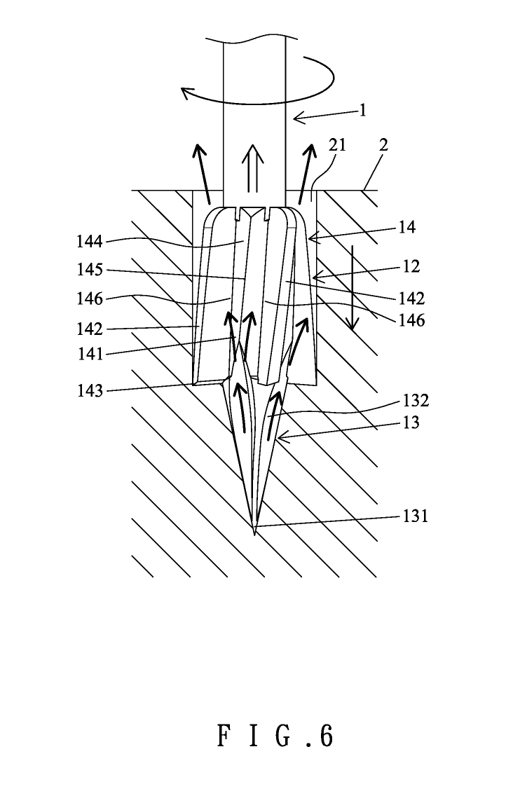

With reference to FIG. 6, a hole 21 with a desired diameter can be obtained after the front cutting ends 143 of the blades 142 of the second cutting section 14 have rotated into the workpiece 2. The wood dust discharged rearward from the first dust grooves 132 can be guided into the second dust grooves 144. Each ridge 145 provides a flow division effect to separate the wood dust in each second dust discharge groove 144 into the two guiding grooves 146 at two sides. The wood dust is then discharged rearward by the guiding air currents to avoid excessive accumulation of the wood dust in each second dust discharge groove 144, providing a better dust discharge effect. Since the first and second cutting sections 13 and 14 include first and second dust discharge grooves 132 and 144 for continuous discharge of wood dust, the wood dust generated during the hole drilling operation will not accumulate in the hole 21 to provide better smoothness in the hole drilling operation while avoiding friction between the wood dust that may lead to high temperature and potential smoking or burning, providing enhanced safety effect.

Although specific embodiments have been illustrated and described, numerous modifications and variations are still possible without departing from the scope of the invention. The scope of the invention is limited by the accompanying claims.

1. A multi-blade type woodworking bit comprising:
a driving section adapted to couple with an external tool; and
a working section located in front of the driving section, with the working section including a first cutting section and a second cutting section behind the first cutting section, with the first cutting section being conic and having a front pointed end, with the first cutting section further including an outer periphery having at least two first dust discharge grooves spaced from each other in an angular direction, with the second cutting section including a shank portion axially connected to a rear end of the first cutting section, with at least two blades extending radially from an outer periphery of the shank portion and spaced from each other in the angular direction, with each of the at least two blades including a front cutting end, with a rear end of each of the at least two first dust discharge grooves located between a pair of blades adjacent to each other, with a second dust discharge groove formed between each pair of blades adjacent to each other and having a width lager than a width of each of the at least two first dust discharge grooves, wherein the second cutting section generates rearward guiding air currents when the multi-blade type woodworking bit rotates.

2. The multi-blade type woodworking bit as claimed in claim 1, wherein each of the at least two blades has a spiral curvature, and each of the at least two first dust discharge grooves has a spiral curvature corresponding to the spiral curvature of one of the at least two blades.

3. The multi-blade type woodworking bit as claimed in claim 1, wherein each of the at least two second dust discharge grooves of the second cutting section includes a ridge extending axially along a central portion thereof, with each ridge including a front end connected to the rear end of one of the at least two first dust discharge grooves, and wherein two guiding grooves for flow division are formed between two sides of each ridge and a pair of blades adjacent to each other.

4. The multi-blade type woodworking bit as claimed in claim 1, wherein the at least two first dust discharge grooves in the outer periphery of the first cutting section include four first dust discharge grooves spaced from each other by 90°, the at least two blades on the shank portion of the second cutting section include four blades spaced from each other by 90°, and the rear end of each of the four first dust discharge grooves is located at a middle between a pair of blades adjacent to each other.
